(19) United States
(12) Patent Application Publication
(10) Pub. No.: US 2019/0270847 A1
(43) Pub. Date: Sep. 5, 2019

(54) METHODS OF FORMING DYNAMIC CROSS-LINKED POLYMER COMPOSITIONS USING FUNCTIONAL CHAIN EXTENDERS UNDER BATCH PROCESS

(71) Applicant: SABIC GLOBAL TECHNOLOGIES B.V., BERGEN OP ZOOM (NL)

(72) Inventors: Husnu Alp Alidedeoglu, Evansville, IN (US); Manojkumar Chellamuthu, Evansville, IN (US); Prashant Kumar, Evansville, IL (US); Ramon Groote, Oisterwijk (NL)

(21) Appl. No.: 16/348,922

(22) PCT Filed: Nov. 15, 2017
(86) PCT No.: PCT/US2017/061734

§ 371 Date: May 10, 2019

Related U.S. Application Data
(60) Provisional application No. 62/422,451, filed on Nov. 15, 2016.

(51) Int. Cl. C08G 63/183; C08G 63/91; C08G 63/85

(52) U.S. Cl. CPC C08G 63/183; C08G 63/916; C08G 63/85; C08G 2650/34; C08G 2650/10; C08G 2650/36; C08G 2650/20

(57) ABSTRACT

Provided herein are methods for preparing dynamic cross-linked polymer compositions derived from an ester oligomer component, a chain extender component, and one or more of a transesterification or poly condensation catalyst are described. The dynamic cross-linked polymer compositions may be prepared via melt poly condensation.

### FIELD

The present disclosure relates to dynamic cross-linked polymer compositions, and more particularly to methods of forming dynamic cross-linked polymer compositions in a batch process using functional chain extenders.

### BACKGROUND

“Dynamic cross-linked polymer compositions” represent a versatile class of polymers. The compositions feature a system of covalently cross-linked polymer networks and can be characterized by the dynamic nature of their structure. At elevated temperatures, it is believed that the cross-links undergo transesterification reactions at such a rate that a flow-like behavior can be observed. Hence, the polymer can be processed much like a viscoelastic thermoplastic. At lower temperatures, these dynamic cross-linked polymer compositions behave more like classic thermosets. As the rate of inter-chain transesterification slows, the network becomes more rigid and static. The dynamic nature of their cross-links allows these polymers to be heated and reheated, and reformed, as the polymers resist degradation and maintain structural integrity at high temperatures.

Previously-described methods of making a dynamic cross-linked polymer composition by combining epoxides and carboxylic acids in the presence of a transesterification catalyst required feeding all components of the polymer into a vessel which was then heated to the processing temperature of the polymer. Once all the starting components were molten, the blend was mixed. During mixing, the cross-linking reaction would take place, which led to an increase in viscosity. While this method is suitable for some small-scale operations, it is cumbersome for larger scales due to difficulties in cleaning the reaction vessels and the stirring implements. In addition, this method does not readily allow for the production of pellets or other forms of material that can be re-worked, for example, by injection molding or profile extrusion.

Further, dynamically cross-linked polybutylene terephthalate (PBT) represent a growing class of dynamically cross-linked compositions. Conventional polybutylene terephthalate resins are semi-crystalline thermoplastics used in a variety of durable goods. PBT resins are now widely used for components in the electronics and automotive industries. Subsequently, the demand for PBT is projected to increase steadily over the coming years. Producers continue to face the challenge of meeting increasing demand for PBT while dealing with higher production costs. One approach to improving process yield and reducing cost on an industrial scale relates to using butylene terephthalate BT-oligomer to make PBT resins. BT-oligomer can be prepared from purified terephthalic acid and butanediol acid. To be useful in making PBT resin for specific end purposes, it is useful to control the carboxylic acid endgroup and intrinsic viscosity of the BT-oligomer.

These and other shortcomings are addressed by aspects of the present disclosure.

### SUMMARY

The above-described needs and other deficiencies of the art are met by the disclosed methods of preparing a dynamically cross-linked polymer composition comprising: combining an alkylene terephthalate oligomer component; one or more of a first catalyst or a second catalyst; and a chain extender or cross-linking agent; to form a slurry; heating the slurry at a first temperature and a first pressure for a first residence time to form a molten mixture; and heating the molten mixture at a second temperature and second pressure for a second residence time, to form a composition having an intrinsic viscosity of between about 0.7 dl/g and 1.2 dl/g and a carboxylic acid end group concentration of between about 10 mmol/kg and 60 mmol/kg.

In some aspects, the present disclosure provides a batch process of preparing a dynamic cross-linked polymer composition, comprising: contacting, an alkylene terephthalate oligomer component, one or both of a first catalyst or a second catalyst, and one or more of a chain extender or cross-linking agent, the contacting being performed so as to form a first mixture; heating the first mixture at a first temperature and a first pressure for a first residence time so as to form a molten mixture; and heating the molten mixture at a second temperature and second pressure for a second residence time so as to give rise to a dynamically cross-linked composition having an intrinsic viscosity of between about 0.55 dl/g and 1.35 dl/g and a carboxylic acid end group concentration of between about 0.1 mmol/kg and 80 mmol/kg.

In further aspects, the present disclosure provides methods of preparing a dynamic cross-linked polymer composition, comprising: contacting a polybutylene terephthalate oligomer component and one or more of a chain extender or cross-linking agent, the contacting being performed so as to form a first mixture; heating the first mixture at a first temperature and a first pressure for a first residence time so as to form a molten mixture; contacting one or more of a first catalyst or a second catalyst to the molten mixture; and heating the molten mixture at a second temperature and second pressure for a second residence time, wherein the second pressure is selected to effect removal of butanediol present in the molten mixture, the removal of the butanediol facilitating polycondensation of the alkylene terephthalate oligomer to form a dynamically cross-linked composition having an intrinsic viscosity of between about 0.55 dl/g and 1.35 dl/g and a carboxylic acid end group concentration of between about 0.1 mmol/kg and 80 mmol/kg.

In yet further aspects, the present disclosure provides processes of forming a dynamically cross-linked composition, the comprising: effecting melt polycondensation of an ester oligomer component and one or more of a chain extender or cross-linking agent in a reactor wherein the pressure in the reactor is reduced to less than 0.016 bar so as to give rise to a dynamically cross-linked composition; wherein the ester oligomer has an intrinsic viscosity of between 0.13 dl/g and 0.35 dl/g and a carboxylic acid end group concentration of between 5 mmol/kg and 180 mmol/g; and wherein the one or more chain extender or cross-linking agent or both is present in an amount between 1 wt. % and 5 wt. % of the total weight of the composition.

In further aspects, the present disclosure relates to a dynamically cross-linked composition formed by a process comprising: effecting melt polycondensation of an ester oligomer component and one or more of a chain extender or cross-linking agent, in a reactor wherein the pressure in the reactor is reduced to less than 0.016 bar, so as to give rise to a dynamically cross-linked composition; wherein the ester oligomer has an intrinsic viscosity of between about 0.13 dl/g and about 0.35 dl/g and a carboxylic acid end group concentration of between about 5 mmol/kg and about 180 mmol/g; wherein the one or more chain extender or cross-linking agent or both is present in an amount between about 1 wt. % and about 5 wt. % of the total weight of the composition; and wherein the dynamically cross-linked composition exhibits the capability of relaxing internal residual stresses at a characteristic timescale of between about 0.1 and about 100,000 seconds above a glass transition temperature of the ester oligomer in a polymerized form, as measured by stress relaxation rheology measurement.

In yet further aspects, the disclosure relates to a dynamically cross-linked composition, comprising: a condensation product of an ester oligomer and one or more of a chain extender or cross-linking agent, wherein the dynamically cross-linked composition exhibits the capability of relaxing internal residual stresses at a characteristic timescale of between about 0.1 and about 100,000 seconds above a glass transition temperature of the ester oligomer in a polymerized form, as measured by stress relaxation rheology measurement.

Articles formed from the described polymer compositions prepared according to the methods herein are also provided herein. Methods may further comprise a method of forming an article formed from the comprising a dynamic cross-linked polymer composition, the method comprising: preparing a dynamic cross-linked polymer composition according to the methods described herein; and subjecting the dynamic cross-linked polymer composition to a polymer forming process so as to give rise to the article. Further disclosed herein are methods of forming an article comprising a dynamic cross-linked polymer composition comprising preparing a dynamic cross-linked polymer composition and subjecting the dynamic cross-linked polymer composition to a conventional polymer forming process, such as compression molding, profile extrusion, injection molding, or blow molding to form the article.

The above described and other features are exemplified by the following drawings, detailed description, examples, and claims.

### BRIEF DESCRIPTION OF THE DRAWINGS

The following is a brief description of the drawings wherein like elements are numbered alike and which are exemplary of the various aspects described herein.

FIG. 1 depicts the storage (solid line) and loss (dashed line) modulus of the oscillatory time sweep measurement curves for a cross-linked polymer network.

FIG. 2 depicts the normalized modulus (G/G₀) for the dynamically cross-linked polymer network (solid line), as well as a line representing the absence of stress relaxation in a conventional cross-linked polymer network (dashed line, fictive data).

FIG. 3 presents Table 1 and exemplary conditions of PBT Oligomer I with PMDA in lab scale polycondensation reactions.

FIG. 4 depicts exemplary stress relaxation curves of PBT-DCN at 1.2 wt. % PMDA cross-linking agent at 230° C. to 290° C. See, e.g., Table 1.

FIG. 5 depicts an Arrhenius plot showing temperature dependence of characteristic relaxation time τ* for sample prepared with 1.2 wt. % PMDA.

FIG. 6 depicts stress relaxation curves of PBT-DCN at varying content of PMDA cross-linking agent at 250° C. See, e.g., Table 2.

FIG. 7 presents Table 2 of the lab scale preparation of PBT DCNs from PBT Oligomer II and PMDA.

FIG. 8 presents Table 3 and reaction conditions and properties of large-scale preparation of PBT DCNs from PBT Oligomer I and PMDA.

### DETAILED DESCRIPTION OF ILLUSTRATIVE ASPECTS

The present disclosure may be understood more readily by reference to the following detailed description of desired aspects and the examples included therein. In the following specification and the claims that follow, reference will be made to a number of terms which have the following meanings.

Described herein are methods of making compositions, i.e., dynamic cross-linked polymer compositions. These compositions are advantageous because they can be prepared more readily than dynamic cross-linkable polymer compositions previously described in the art.

### Definitions

Unless otherwise defined, all technical and scientific terms used herein have the same meaning as commonly understood by one of ordinary skill in the art. It is to be understood that the terminology used herein is for the purpose of describing particular aspects only and is not intended to be limiting. In this specification and in the claims which follow, reference will be made to a number of terms which shall be defined herein. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” may include the aspects “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Numerical values in the specification and claims of this application, particularly as they relate to polymers or polymer compositions, oligomers or oligomer compositions, reflect average values for a composition that may contain individual polymers or oligomers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

Ranges can be expressed herein as from one value (first value) to another value (second value). When such a range is expressed, the range includes in some aspects one or both of the first value and the second value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. As used herein, the terms “about” and “at or about” mean that the amount or value in question can be the designated value, approximately the designated value, or about the same as the designated value. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

As used herein, “Tm” refers to the melting point at which a polymer, or oligomer, completely loses its orderly arrangement.

As used herein, “Tc” refers to the crystallization temperature at which a polymer gives off heat to break a crystalline arrangement.

The terms “Glass Transition Temperature” or “Tg” refer to the maximum temperature at which a polymer will still have one or more useful properties. These properties include impact resistance, stiffness, strength, and shape retention. The Tg therefore may be an indicator of its useful upper temperature limit, particularly in plastics applications. The Tg may be measured using a differential scanning calorimetry method and expressed in degrees Celsius.

As used herein, the terms “terephthalic acid group” and “isophthalic acid group” (“diacid groups”) “butanediol group,” “alcohol group,” “aldehyde group,” and “carboxylic acid group,” being used to indicate, for example, the weight percent of the group in a molecule, the term “isophthalic acid group(s)” means the group or residue of isophthalic acid having the formula (—(CO)C₆H₄(CO)—), the term “terephthalic acid group” means the group or residue of isophthalic acid having the formula (—(CO)C₆H₄(CO)—), the term “butanediol group” means the group or residue of butanediol having the formula (—(C₄H₈)—), the term “alcohol group” means the group or residue of hydroxide having the formula (—(OH)—), the term “aldehyde group” means the group or residue of an aldehyde having the formula (—(CHO)—), and the term “carboxylic acid group” means the group or residue of a carboxylic acid having the formula (—(COOH)—).

As used herein, “crosslink,” and its variants, refer to the formation of a stable covalent bond between two polymers. This term is intended to encompass the formation of covalent bonds that result in network formation, or the formation of covalent bonds that result in chain extension. The term “cross-linkable” refers to the ability of a polymer to form such stable covalent bonds.

As used herein, “dynamic cross-linked polymer composition” refers to a class of polymer systems that include dynamically, covalently cross-linked polymer networks. At low temperatures, dynamic cross-linked polymer compositions behave like classic thermosets, but at higher temperatures, for example, temperatures up to about 320° C., it is theorized that the cross-links have dynamic mobility, resulting in a flow-like behavior that enables the composition to be processed and re-processed. Dynamic cross-linked polymer compositions incorporate covalently cross-linked networks that are able to change their topology through thermo-activated bond exchange reactions. The network is capable of reorganizing itself without altering the number of cross-links between its atoms. At high temperatures, dynamic cross-linked polymer compositions achieve transesterification rates that permit mobility between crosslinks, so that the network behaves like a flexible rubber. At low temperatures, exchange reactions are very long and dynamic cross-linked polymer compositions behave like classical thermosets. The transition from the liquid to the solid is reversible and exhibits a glass transition. Put another way, dynamic cross-linked polymer compositions can be heated to temperatures such that they become liquid without suffering destruction or degradation of their structure. The viscosity of these materials varies slowly over a broad temperature range, with behavior that approaches the Arrhenius law. Because of the presence of the crosslinks, a dynamic cross-linked polymer composition will not lose integrity above the Tg or Tm like a thermoplastic resin will. The crosslinks are capable of rearranging themselves via bond exchange reactions between multiple crosslinks and/or chain segments as described, for example, by Kloxin and Bowman, Chem. Soc. Rev. 2013, 42, 7161-7173. The continuous rearrangement reactions may occur at room or elevated temperatures depending upon the dynamic covalent chemistry applicable to the system. The respective degree of cross-linking may depend on temperature and stoichiometry. Dynamic cross-linked polymer compositions of the disclosure can have Tg of about 40° C. to about 60° C. An article made from a dynamic cross-linked polymer composition can be heated and deformed, and upon returning to the original temperature, maintains the deformed shape. As such, articles in accordance with the present disclosure may comprise a shape generated by applying mechanical forces to a molded piece formed from the dynamic cross-linked polymer composition. This combination of properties permits the manufacture of shapes that are difficult or impossible to obtain by molding or for which making a mold would not be economical. Dynamic cross-linked polymer compositions generally have good mechanical strength at low temperatures, high chemical resistance, and low coefficient of thermal expansion, along with processability at high temperatures. Examples of dynamic cross-linked polymer compositions are described herein, as well as in U.S. Patent Application No. 2011/0319524, WO 2012/152859; WO 2014/086974; D. Montarnal et al., Science 334 (2011) 965-968; and J. P. Brutman et al, ACS Macro Lett. 2014, 3, 607-610. As an example, articles may be formed from the dynamic cross-linked polymer compositions of the present disclosure and may include composites, a thermoformed material, or a combination thereof. The articles may further comprise a solder bonded to the formed article.

Examining the nature of a given polymer composition can distinguish whether the composition is cross-linked, reversibly cross-linked, or non-cross-linked, and distinguish whether the composition is conventionally cross-linked or dynamically cross-linked. Dynamically cross-linked networks feature bond exchange reactions proceeding through an associative mechanism, while reversible cross-linked networks feature a dissociative mechanism. That is, the dynamically cross-linked composition remains cross-linked at all times, provided the chemical equilibrium allowing cross-linking is maintained. A reversibly cross-linked network however shows network dissociation upon heating, reversibly transforming to a low-viscous liquid and then reforming the cross-linked network upon cooling. Reversibly cross-linked compositions also tend to dissociate in solvents, particularly polar solvents, while dynamically cross-linked compositions tend to swell in solvents as do conventionally cross-linked compositions.

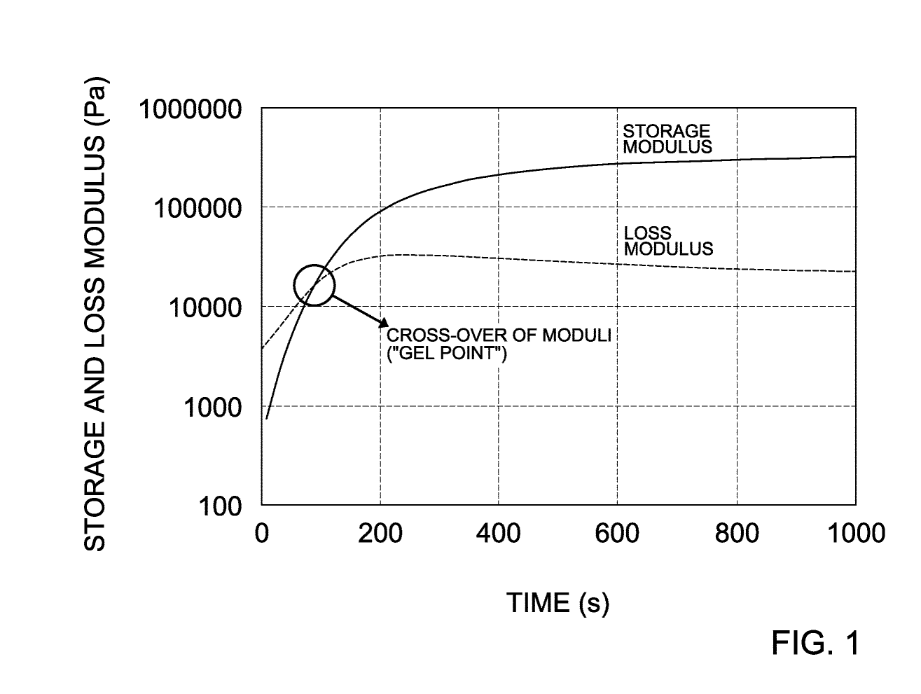

The cross-linked network apparent in dynamic and other conventional cross-linked systems may also be identified by rheological testing. An oscillatory time sweep (OTS) measurement at fixed strain and temperature may be used to confirm network formation. Exemplary OTS curves are presented in FIG. 1 for a cross-linked polymer network.

The orientation of the curves indicates whether or not the polymer has a cross-linked network. Initially, the loss modulus (viscous component) has a greater value than the storage modulus (elastic component) indicating that the material behaves like a viscous liquid. Polymer network formation is evidenced by the intersection of the loss and storage modulus curves. The intersection, referred to as the “gel point,” represents when the elastic component predominates the viscous component and the polymer begins to behave like an elastic solid.

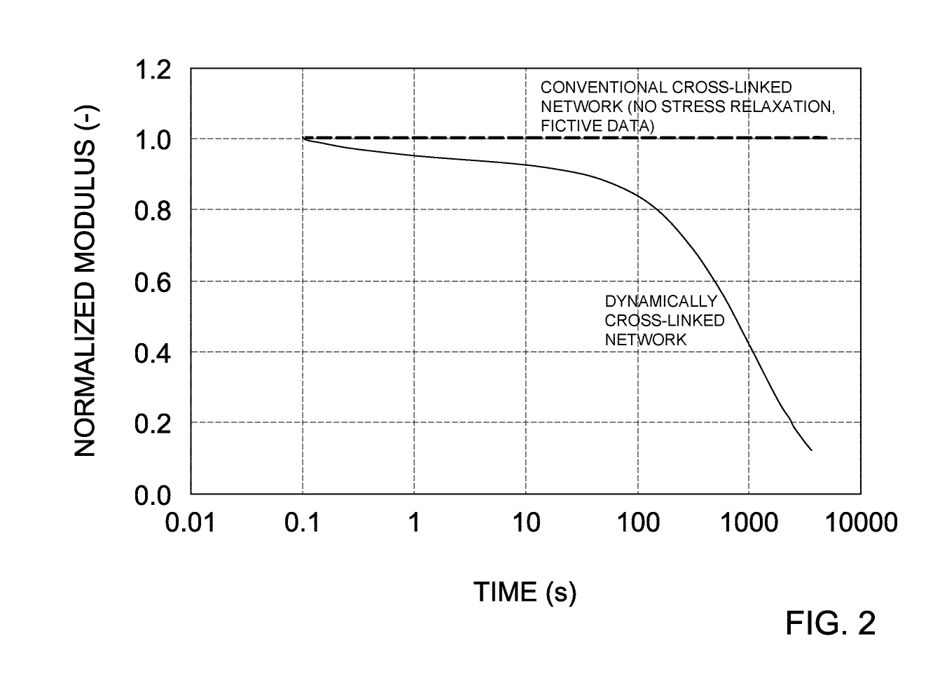

In distinguishing between dynamic cross-linking and conventional (or non-reversible) cross-linking, a stress relaxation measurement may also, or alternatively, be performed at constant strain and temperature. After network formation, the polymer may be heated and certain strain imposed on the polymer. The resulting evolution of the elastic modulus as a function of time reveals whether the polymer is dynamically or conventionally cross-linked. Exemplary curves for dynamically and conventionally cross-linked polymer networks are presented in FIG. 2.

Stress relaxation generally follows a multimodal behavior:

$$G / {G}_{0} = {\sum }_{i = 1}^{n} {C}_{i} exp ( - t / {τ}_{i} ) ,$$

where the number (n), relative contribution (Cᵢ) and characteristic timescales (τᵢ) of the different relaxation modes are governed by bond exchange chemistry, network topology and network density. For a conventional cross-linked networks, relaxation times approach infinity, τ→∞, and G/G₀=1 (horizontal dashed line). Apparent in the curves for the normalized modulus (G/G₀) as a function of time, a conventionally cross-linked network does not exhibit any stress relaxation because the permanent character of the cross-links prevents the polymer chain segments from moving with respect to one another. A dynamically cross-linked network, however, features bond exchange reactions allowing for individual movement of polymer chain segments thereby allowing for complete stress relaxation over time.

If the networks are DCNs, the networks may be able to relax any residual stress that is imposed on the material as a result of network rearrangement at higher temperature. The relaxation of residual stresses with time can be described with single-exponential decay function, having only one characteristic relaxation time τ*:

$$G ( t ) = G ( 0 ) \times exp ( - \frac{t}{{τ}^{*}} )$$

A characteristic relaxation time can be defined as the time needed to attain particular G(t)/G(0) at a given temperature. At lower temperature, stress relaxes slower, while at elevated temperature network rearrangement becomes more active and hence stress relaxes faster, proving the dynamic nature of the network. The influence of temperature on stress relaxation modulus clearly demonstrates the ability of cross-linked network to relieve stress or flow as a function of temperature.

Additionally, the influence of temperature on the stress relaxation rate in correspondence with transesterification rate were investigated by fitting the characteristic relaxation time, τ* to an Arrhenius type equation.

ln τ*=−Eₐ/RT+ln A

where Eₐ is the activation energy for the transesterification reaction, A is the frequency factor, and R is the gas constant.

Described herein are methods of preparing dynamic cross-linked polymer compositions via a melt polycondensation reaction. According to these methods, an alkylene terephthalate oligomer component, one or both of a first catalyst or a second catalyst, and one or more of a chain extender or cross-linking agent, may be contacted in a reaction vessel so as to form a first mixture. The first mixture may be heated at a first temperature and a first pressure for at least a first residence time so as to form a molten mixture. The resulting molten mixture may be heated at a second temperature and second pressure for a second residence time so as to give rise to a dynamically cross-linked composition having an intrinsic viscosity (IV) of between about 0.55 deciliters per gram (dl/g) and about 1.35 dl/g and a carboxylic acid end group (CEG) concentration of between about 0.1 millimol per kilogram (mmol/kg) and about 80 mmol/kg.

In one aspect, the alkylene terephthalate oligomer component, one or both of a first catalyst or a second catalyst, and one or more of a chain extender or cross-linking agent may be combined at atmospheric pressure (between about 0.8 bar and about 1.1 bar) at a temperature of up to about 260° C. for about 40 minutes or fewer until the foregoing components form a molten mixture. The resulting resultant molten mixture may undergo polycondensation at a second temperature and a second pressure (e.g., a reduced vacuum pressure of less than 16 millibar (mbar) (0.016 bar)) under an inert atmosphere and for a second residence time of up to about 90 minutes.

In some methods, the combination of the alkylene terephthalate oligomer component, the chain extender, and the one or both of a first catalyst or a second catalyst may be carried out at a pressure that is less than atmospheric pressure. For example, in some aspects, the combination of the oligomer component the chain extender and the one or both of a first catalyst or a second catalyst, is carried out in a vacuum. In further aspects, the pressure of the molten mixture may be reduced to a polycondensation pressure such that the polycondensation pressure is less than the first pressure to form the molten mixture. As an example, the pressure in the reactor may be gradually decreased to less than 8 mbar, specifically less than 2 millibar (mbar), for a sufficient polycondensation pressure.

In preferred aspects, the heating of the alkylene terephthalate oligomer component, the one or both of a first catalyst or a second catalyst and chain extender occurs for less than about 60 minutes to form the molten mixture. In other aspects, the heating to form the molten mixture occurs for less than about 40 minutes. In yet other aspects, the combining to form the molten mixture occurs for less than about 30 minutes. In still other aspects, the heating of the first mixture to form the molten mixture occurs for between about 20 minutes and about 30 minutes.

In various aspects of the present disclosure, the heating step at a first temperature to provide a molten mixture occurs at a temperature sufficient to form a homogenous melt of the alkylene terephthalate oligomer component. Thus, the combining step to provide a molten mixture may occur at or about a melting temperature of the oligomer component.

In some aspects, the heating step to provide a molten mixture occurs at temperatures of up to 290° C. or up to about 290° C. In yet other aspects, the heating step occurs at temperatures of between 40° C. and 290° C. or between about 40° C. and about 290° C. In other aspects, the heating step occurs at temperatures of between 40° C. and 270° C. or between about 40° C. and about 270° C. In some aspects, the heating step occurs at temperatures of between 40° C. and 260° C. or between about 40° C. and about 260° C. In yet other aspects, the heating step occurs at temperatures of between 70° C. and 290° C. or between about 70° C. and about 290° C. In still other aspects, the heating step occurs at temperatures of between 190° C. and 290° C. or between about 190° C. and about 290° C. In other aspects, the heating step occurs at temperatures of between 190° C. and 240° C. or between about 190° C. and about 240° C.

In various aspects of the present disclosure, the heating step occurs at a temperature less than the temperature of degradation of the respective ester oligomer component. As an example, the combining step occurs at a temperature less than or about equal to the Tm of the respective ester oligomer. In one example, the heating step occurs at 240° C. to 260° C. or at about 240° C. to 260° C., below the degradation temperature of BT-oligomer.

The heating step to provide a molten mixture can be achieved using any means known in the art, for example, mixing, blending, stirring, shaking, and the like in a reactor or vessel equipped with an appropriate heat source. A preferred method combining the ester oligomer component, the monomeric chain extender, the transesterification catalyst, and the polycondensation catalyst to provide a molten mixture is to use a melt reactor. As an example, a melt reactor or vessel can be charged with the foregoing components.

In various aspects of the present disclosure, the obtained molten mixture is heated to enable a polycondensation reaction to occur, and heating is carried out at a second temperature (e.g., a “polycondensation temperature”) and at a second pressure (e.g., a “polycondensation pressure”) sufficient and for a time sufficient to provide a dynamically cross-linked composition. In some aspects, the polycondensation reaction occurs at temperatures of up to 260° C. or up to about 260° C. In some aspects, the polycondensation occurs at temperatures of between 40° C. and 260° C. or between about 40° C. and about 260° C. In other aspects, the polycondensation occurs at temperatures of between 40° C. and 250° C. or between about 40° C. and about 250° C. In some aspects, the polycondensation occurs at temperatures of between 40° C. and 240° C. or between about 40° C. and about 240° C. In yet other aspects, the polycondensation occurs at temperatures of between 70° C. and 260° C. or between about 70° C. and about 260° C. In yet other aspects, the polycondensation occurs at temperatures of between 190° C. and 260° C. or between about 190° C. and about 260° C. In still other aspects, the polycondensation occurs at temperatures of between 190° C. and 250° C. or between about 190° C. and about 250° C. In other aspects, the polycondensation occurs at temperatures of between 190° C. and 240° C. or between about 190° C. and about 240° C.

In some aspects of the present disclosure, the polycondensation occurs at a temperature less than the temperature of degradation of the respective ester oligomer component. As an example, the polycondensation occurs at a temperature less than or about equal to the Tm of the respective ester oligomer. In one example, where the ester oligomer is BT-oligomer the polycondensation step occurs at 240° C. to 260° C. or at about 240° C. to 260° C., below the degradation temperature of BT-oligomer.

The heating the molten mixture at a second pressure, or a polycondensation temperature, occurs at a sufficient pressure to provide a dynamically cross-linked composition. In an aspect, the second pressure is less than the first pressure at which the components are combined and melted. In some aspects, the polycondensation reaction occurs at a pressure of less than 16 mbar, preferably between 0.1 mbar and 16 mbar or between about 0.1 mbar and 16 mbar. In one example, the polycondensation reaction may occur at a second pressure below 8 mbar, specifically, below 2 mbar. In a specific example, the preparation of the dynamically cross-linked composition may proceed in a single batch process where pressure may be reduced from the pressure applied during heating of the molten mixture in order to initiate a polycondensation reaction. In one example, the second pressure may be 3 mbar to 4 mbar or about 3 mbar to about 4 mbar.

In yet further aspects of the present disclosure, the molten mixture is heated at a second temperature and at a second pressure for a time sufficient to initiate polycondensation and to form the dynamic cross-linked polymer composition having an intrinsic viscosity of between 0.55 dl/g and 1.35 dl/g or between about 0.55 dl/g and about 1.35 dl/g. The molten mixture undergoes a polycondensation reaction for a sufficient residence time as the desired temperature and decreased pressure. In an aspect, the residence time for the polycondensation reaction can be up to 90 minutes or up to about 90 minutes. In other aspects, the polycondensation residence time occurs for up to 80 minutes or up to about 80 minutes. In yet other aspects, the polycondensation residence time occurs for up to 70 minutes or up to about 70 minutes. In still other aspects, the polycondensation residence time occurs for between 30 minutes and 80 minutes or between about 30 minutes and about 80 minutes. In preferred aspects, the polycondensation reaction of the molten mixture occurs for 65 minutes or about 65 minutes to form the dynamic cross-linked polymer composition.

In an aspect, the preparation of the dynamically cross-linked polymer composition may proceed in a single reaction vessel. As an example, the reaction may proceed in a reactor vessel equipped with a reflux distillation apparatus such as a condenser. The reactor vessel and condenser may further comprise a receiver or distilling component, such as a Dean-Stark trap, to collect water formed during the preparation of the dynamically cross-linked polymer composition.

As an exemplary process, oligomers may be flaked, powdered, or pelletized into a reaction vessel where the oligomer is heated to between 220° C. and 260° C., or between about 220° C. and about 260° C., to achieve a flowable melt. The melt process may occur at atmospheric pressure and may proceed under an inert atmosphere. Heating of the reactor may be achieved according to a number of well-known methods in the art. For example, heating may be achieved using an oil bath. After a residence time to ensure complete molten formation of the contents of the reactor, the temperature is increased to between 250° C. and 260° C. The melt residence time can be up to about 30 minutes. The pressure may be reduced to less than about 8 mbar, preferably less than 2 mbar, (a polycondensation pressure) for a residence time sufficient for polycondensation to occur for the formation of the dynamically cross-linked network. The polycondensation residence time can be up to about 70 minutes.

The methods described herein can be carried out under ambient atmospheric conditions, but the methods may be carried out under an inert atmosphere, for example, a nitrogen atmosphere. Preferably, the methods are carried out under conditions that reduce the amount of moisture in the resulting dynamic cross-linked polymer compositions described herein. For example, preferred dynamic cross-linked polymer compositions described herein will have less than 3 weight percent (wt. %) or less than about 3.0 wt. %, less than 2.5 wt. % or less than about 2.5 wt. %, less than 2.0 wt. % or less than about 2.0 wt. %, less than 1.5 wt. % or less than about 1.5 wt. %, or less than 1.0 wt. % or less than about 1.0 wt. % of water (i.e., moisture), based on the weight of the dynamic cross-linked polymer composition.

The components of the reactor vessel may be combined in a number of ways. In some aspects, the first and second catalysts (i.e., the transesterification and polycondensation catalysts) and chain extenders may be introduced to the reactor under stirring. In further aspects, the first and second catalysts and the chain extenders may be introduced to the reactor vessel before heating to form a molten mixture. In yet further aspects, the first and second catalysts and the chain extenders may be introduced to the reactor vessel after the oligomer component has been heated to form a molten mixture.

In some aspects, the batch process may be performed in a reactor vessel with combining abilities, for example, mixing, including screw mixing, blending, stirring, shaking, and the like. In one example, the method may be achieved in an extruder apparatus, for example, a single screw or twin screw extruding apparatus. The ester oligomer, chain extender or cross-linking agent, and catalyst may be compounded in a reactive extruder.

The compositions of the present disclosure provide dynamically cross-linked compositions exhibiting the characteristic stress-relaxation behavior associated with formation of a dynamic network. In certain aspects of the present disclosure, to achieve a fully cured, dynamic cross-linked composition, compositions prepared herein undergo a post-curing step. The post-curing step may include heating the obtained composition to elevated temperatures for a prolonged period. The composition may be heated to a temperature just below the melt or deformation temperature. Heating to just below the melt or deformation temperature activates the dynamically cross-linked network, thereby, curing the composition to a dynamic cross-linked polymer composition.

A composition, formed according to the present disclosure described herein, when subjected to a curing process may exhibit a plateau modulus of from about 0.01 megapascals (MPa) to about 1000 MPa, or from 0.01 MPa to 1000 MPa, at a temperature above the melting temperature (and, depending on the polymer, above the glass transition temperature) of the ester oligomer component as measured by dynamic mechanical analysis. The cured pre-dynamic cross-linked polymer composition may further exhibit the capability of relaxing internal residual stresses at a characteristic timescale of between 0.1 and 100,000 seconds above the glass transition temperature of the ester oligomer component, as measured by a stress relaxation rheology measurement. It should be understood that in the case of some polymers, (including some semi-crystalline polymers, e.g., PBT) the cured pre-dynamic cross-linked polymer composition may further exhibit the capability of relaxing internal residual stresses at a characteristic timescale of between 0.1 and 100,000 seconds above the Tm for that polymer.

A post-curing step may be useful to activate the dynamic cross-linked network in certain compositions of the present disclosure. Certain chain extenders or cross-linking agents may require that a post-curing step is performed to facilitate the formation of the dynamically cross-linked network. For example, a post-curing step may be useful for a composition prepared with a less reactive chain extender or cross-linking agent. Less reactive chain extenders or cross-linking agents may include epoxy chain extenders that generate secondary alcohols in the presence of a suitable catalyst. In one example, the composition prepared from an ERL epoxy is heated at 250° C. for about 30 minutes. In yet further aspects of the present disclosure, certain compositions exhibit dynamically cross-linked network formation after a shorter post-curing step. In yet further aspects, compositions may attain a dynamically cross-linked network formation and need not undergo a post-curing step. That is, these compositions may not require additional heating to achieve the dynamically cross-linked network. In some aspects, compositions derived from more reactive chain extenders exhibit dynamically cross-linked network behavior without heating. More reactive chain extenders can include epoxy chain extenders that generate primary alcohols in the presence of a suitable catalyst. In some examples, the reactive chain extender may be reactive with the carboxylic acid groups of the alkylene terephthalate oligomer component.

The dynamic cross-linked polymer compositions can be formed into any shape known in the art. Such shapes can be convenient for transporting the dynamic cross-linked polymer compositions described herein. Alternatively, the shapes can be useful in the further processing of the dynamic cross-linked polymer compositions described herein into dynamic cross-linked polymer compositions and articles comprising them. For example, the dynamic cross-linked polymer compositions can be formed into pellets. In other aspects, the dynamic cross-linked polymer compositions can be formed into flakes. In still further aspects, the dynamic cross-linked polymer compositions can be formed into powders.

The dynamic cross-linked polymer compositions described herein can be use in conventional polymer forming processes such as, for example, injection molding, compression molding, profile extrusion, blow molding, and the like. For example, dynamic cross-linked polymer compositions prepared according to the described methods can be melted and then injected into an injection mold to form an injection-molded article. The injection-molded article can then be cured by heating to temperatures of up to 320° C. or up to about 320° C., followed by cooling to ambient temperature. As an example, articles may be formed from the dynamic cross-linked polymer compositions of the present disclosure and may include composites, a thermoformed material, or a combination thereof. The articles may further comprise a solder bonded to the formed article.

Alternatively, the dynamic cross-linked polymer compositions described herein can be melted, subjected to compression molding processes, and then cured. In other aspects, the dynamic cross-linked polymer compositions described herein can be melted, subjected to profile extrusion processes, and then cured. In some aspects, the dynamic cross-linked polymer compositions described herein can be melted, subjected to blow molding processes, and then cured. The individual components of the dynamic cross-linked polymer compositions are described in more detail herein.

### Ester Oligomer Component

Present in the compositions described herein are oligomers that have ester linkages. The oligomer can contain only ester linkages between monomers. The oligomer can also contain ester linkages and potentially other linkages as well.

In some aspects, the oligomer component can comprise oligomers containing ethylene terephthalate groups, oligomers containing ethylene isophthalate groups, oligomers containing diethylene terephthalate groups, oligomers containing diethylene isophthalate groups, oligomers containing butylene terephthalate groups, oligomers containing butylene isophthalate groups, and covalently bonded oligomeric groups containing at least two of the foregoing groups.

In a preferred aspect, the oligomer can comprise an oligomer having “n” the degree of polymerization and represents the number of units of butylene terephthalate groups. The oligomer having ester linkages can be an alkylene terephthalate, for example, an oligomer containing butylene terephthalate, described herein as BT-oligomer, which has the structure shown below:

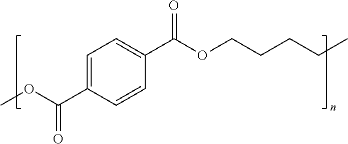

where n is the degree of polymerization, and can have a value between 1 and 15. The oligomer may have an intrinsic viscosity between 0.09 dl/g and 0.35 dl/g. The oligomer having ester linkages can be an oligomer containing ethylene terephthalate, described herein as an ET-oligomer, which has the structure shown below:

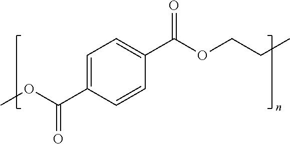

where n is the degree of polymerization, and can have a value between 1 and 15. The ethylene terephthalate oligomer may have an intrinsic viscosity between 0.09 dl/g and 0.35 dl/g.

The polymer having ester linkages can be a CTG-oligomer, which refers to an oligomer containing (cyclohexylenedimethylene terephthalate), glycol-modified groups. The oligomer is a copolymer formed from 1,4-cyclohexanedimethanol (CHDM), ethylene glycol, and terephthalic acid. The two diols react with the diacid to form a copolyester. The resulting copolyester has the structure shown below:

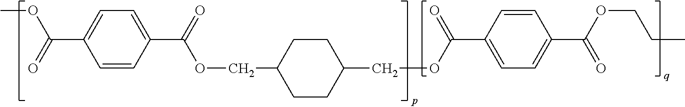

where p is the molar percentage of repeating units derived from CHDM, q is the molar percentage of repeating units derived from ethylene glycol, and p>q. The CTG-oligomer may have an intrinsic viscosity between 0.09 dl/g and 0.35 dl/g. The oligomer having ester linkages can also be ETG-oligomer. ETG-oligomer has the same structure as CTG-oligomer, except that the ethylene glycol is 50 mole % or more of the diol content. ETG-oligomer is an abbreviation for an oligomer containing ethylene terephthalate, glycol-modified. The oligomer having ester linkages can contain 1,4-cyclohexane-dimethanol-1,4-cyclohexanedicarboxylate units, having the structure shown below:

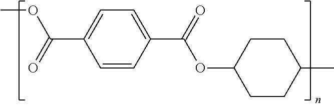

where n is the degree of polymerization, and can have a value between 1 and 15. The oligomer having ester linkages can contain 1,4-cyclohexane-dimethanol-1,4-cyclohexanedicarboxylate units may have an intrinsic viscosity between 0.09 dl/g and 0.35 dl/g.

The oligomer having ester linkages can contain ethylene naphthalate units and have the structure shown below:

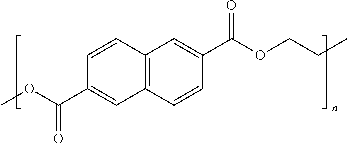

where n is the degree of polymerization, and can have a value between 1 and 15. The oligomer may have an intrinsic viscosity between 0.09 dl/g and 0.35 dl/g.

Aliphatic esters can also be used as the oligomers described herein. Examples of aliphatic esters include esters having repeating units of the following formula:

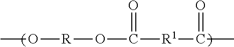

where at least one R or R¹ is an alkyl-containing radical. They are prepared from the polycondensation of glycol and aliphatic dicarboxylic acids. The aliphatic ester oligomer may have an intrinsic viscosity between 0.09 dl/g and 0.35 dl/g.

The oligomer having ester linkages can also include ester carbonate linkages. The ester carbonate linkages contains two sets of repeating units, one having carbonate linkages and the other having ester linkages. This is illustrated in the structure below:

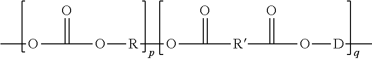

where p is the molar percentage of repeating units having carbonate linkages, q is the molar percentage of repeating units having ester linkages, and p+q=100%; and R, R′, and D are independently divalent radicals.
In various aspects of the present disclosure, the ester oligomer can have an intrinsic viscosity between 0.09 dl/g and 0.35 dl/g. An intrinsic viscosity between 0.09 dl/g and 0.35 dl/g can correspond to an average molecular weight of between 1000 and 3500 Daltons. Further, the ester oligomer can have a particular carboxylic acid endgroup concentration (CEG). In some aspects, the ester oligomer can have a carboxylic acid endgroup concentration between about 20 and 120 mmol/kg.

In one aspect, the preferred oligomer is an ester containing butylene terephthalate, referred to herein as a (butylene terephthalate) oligomer or BT-oligomer. The BT-oligomer can have an intrinsic viscosity between 0.09 dl/g and 0.35 dl/g, or about 0.13 dl/g to about 0.35 dl/g. In a preferred aspect, the BT-oligomer can have an intrinsic viscosity of 0.11 dl/g or about 0.11 dl/g. The BT-oligomer can have a carboxylic acid endgroup concentration between 5 mmol/kg and 180 mmol/kg or between about 5 mmol/kg and 180 mmol/kg, or between 20 mmol/kg and 120 mmol/kg or between about 20 mmol/kg and 120 mmol/kg. As an example, the BT-oligomer can have a carboxylic acid endgroup concentration of about 100 mmol/kg.

In some aspects, the BT-oligomer can be derived from purified terephthalic acid. As an example, the BT-oligomer may be prepared from a batch polycondensation process comprising combining a portion of butanediol (BDO) acid pre-heated to about 100° C. with purified terephthalic acid in a reaction vessel to provide a first mixture, and heating the mixture to between 240° C. and 260° C. At about 170° C., a polycondensation catalyst such as titanium(IV) isopropoxide (TPT) can be mixed with a portion of BDO and introduced to the reaction vessel. The reaction vessel can be equipped with a column and condenser to direct condensate away from the reaction vessel. At the desired melt temperature of the BT-oligomers (at about 248° C. to 250° C.), the temperature is maintained and samples of the reaction vessel contents can be evaluated for the desired IV and CEG. The resultant BT-oligomer can be cooled and pelletized, or flaked, and ground to a fine powder to facilitate in even melting of the BT-oligomer for preparation of the dynamically cross-linked composition.

The compositions of the present disclosure include an ester oligomer component. The ester oligomer component is present in an amount between 90 wt. % and 95 wt. %.

### Chain Extender/Cross-Linking Agent Component

The compositions of the present disclosure include a chain extender or a cross-linking agent. The chain extender, or cross-linking agent, of the present disclosure can be a monomeric or a polymeric compound. compound. In an aspect, the chain extender can be functional, that is, the chain extender may exhibit reactivity with one or more groups of a given chemical structure. Suitable chain extenders or cross-linking agents may comprise a diepoxy, a diisocyanide, a dianhydride, a dioxazoline, a polyol, or a combination thereof. In further examples, the chain extenders described herein may be characterized by one of two reactivities with groups present within the ester oligomer component. The chain extender may react with (1) the carboxylic acid end group moiety or (2) the alcohol end group moiety of the ester oligomer component.

Useful monomeric chain extenders exhibiting reactivity with the carboxylic groups of the ester oligomer include epoxy based chain extenders. Various epoxy chain extenders or crosslinking agent and their feed amount may largely affect the networks' property by affecting the crosslinking density and transesterification dynamic. The epoxy moiety of the monomeric chain extender may directly react with the carboxylic acid endgroup of the ester oligomer in the presence of the transesterification catalyst. In an aspect, the epoxy-containing chain extender may be multi-functional, that is having at least two epoxy groups. The epoxy-chain extender generally has at least two epoxy groups, and can also include other functional groups as desired, for example, hydroxyl (—OH). Glycidyl epoxy resins are a particularly preferred epoxy-containing component.

Exemplary epoxy based chain extenders include a bisphenol A (BPA) epoxy shown in Formula A (bisphenol A diglycidyl ether, BADGE) and a cycloaliphatic epoxy (ERL) shown in Formula B. The cycloaliphatic epoxy (ERL) may comprise ERL™-4221 (3,4-epoxy cyclohexyl methyl-3,4-epoxy cyclohexyl carboxylate).

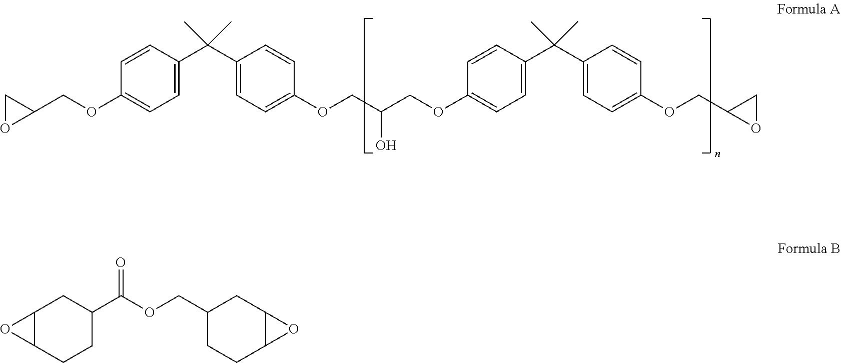

For a monomeric bisphenol A epoxy, the value of n is 0 in Formula (A). When n=0, this is a monomer. BADGE-based resins have excellent electrical properties, low shrinkage, good adhesion to numerous metals, good moisture resistance, good heat resistance and good resistance to mechanical impacts. In some aspects of the present disclosure, the BADGE has a molecular weight of about 1000 Daltons and an epoxy equivalent of about 530 grams per equivalent. As used herein, the epoxy equivalent is an expression of the epoxide content of a given compound. The epoxy equivalent is the number of epoxide equivalents in 1 g of resin (eq./g).

Preferred epoxy chain extenders of the present disclosure include monomeric epoxy compounds which generate a primary alcohol. In the presence of a suitable catalyst, the generated primary alcohol can readily undergo transesterification. As an example, and not to be limiting, exemplary epoxy chain extenders that generate a primary alcohol include certain cyclic epoxies. Exemplary cyclic epoxies that generate a primary alcohol in the presence of a suitable catalyst have a structure according to Formula C.

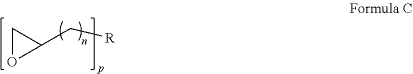

where n is greater than or equal to 1 and R can be any chemical group (including, but not limited to, ether, ester, phenyl, alkyl, alkynyl, etc.). In preferred aspects of the present disclosure, p is greater than or equal to 2 such that there are at least 2 of the epoxy structural groups present in the chain extender molecular. BADGE is an exemplary epoxy chain extender where R is bisphenol A, n is 1, and p is 2.

Other exemplary monomeric epoxy chain extenders include diglycidyl benzenedicarboxylate (Formula D) and triglycidyl benzene tricarboxylate (Formula E).

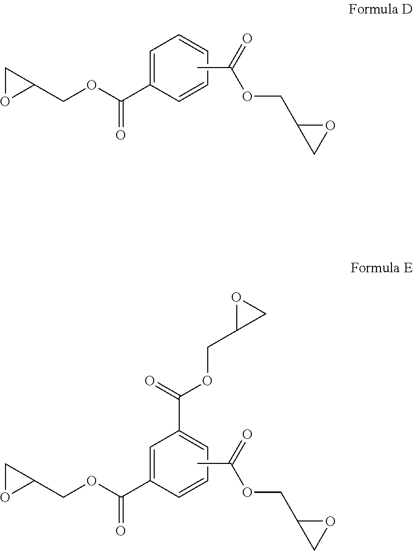

The epoxy-based monomeric chain extender may be present as a component as a percentage of the total weight of the composition. In some aspects, the epoxy-based monomeric chain extender may be present in an amount of from about 1 wt. % to about 10 wt. %, or from 1 wt. % to less than 5 wt. %. For example, the epoxy-based monomeric chain extender may be present in an amount of about 1, 2, 3, 4, 5, 6, 7, 8, 9, or about 10 wt. %. In one aspect, the epoxy-based monomeric chain extender may be present in an amount of about 2.5 wt. %.

As noted herein, the monomeric chain extender is a compound reactive with the alcohol moiety present in the ester oligomer component. Such chain extenders include a dianhydride compound. The dianhydride compound facilitates network formation by undergoing direct esterification with the ester oligomer. In the presence of a suitable catalyst, the dianhydride can undergo ring opening, thereby generating carboxylic acid groups. The generated carboxylic acid groups undergo direct esterification with the alcohol groups of the ester oligomer.

Exemplary chain extenders or cross-linking agents according to the methods disclosed herein may include a diepoxy, a diisocyanide, a dianhydride, a dioxazonine, a polyol, or a combination thereof. The foregoing chain extenders include polymeric and monomeric chain extenders. An exemplary class of monomeric chain extender that is reactive with the alcohol moiety present in the ester oligomer includes dianhydrides. A preferred dianhydride is a pyromellitic dianhydride as provided in Formula F.

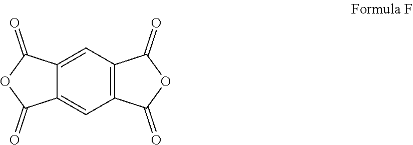 [SMILES: O=c1oc(=O)c2cc3c(=O)oc(=O)c3cc12]

Useful polymeric chain extenders exhibiting reactivity with the carboxylic groups of the ester oligomer include chain extenders having high epoxy functionality. High epoxy functionality can be characterized by the presence of between 200 and 300 equivalent per mol (eq/mol) of glycidyl epoxy groups.

An exemplary polymeric chain extenders is an epoxidized styrene-acrylic copolymer CESA. CESA is a copolymer of styrene, methyl methacrylate, and glycidyl methacrylate below.

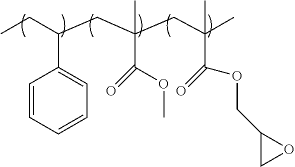

A preferred CESA according to the methods of the present disclosure has average molecular weight of 6800 g/mol or about 6800 g/mol and an epoxy equivalent of 280 g/mol. As used herein, the epoxy equivalent is an expression of the epoxide content of a given compound. The epoxy equivalent is the number of epoxide equivalents in 1 kg of resin (eq./g).

The polymeric chain extender may be present as a component as a percentage of the total weight of the composition. In some aspects, the polymeric chain extender may be present in an amount of from 1 wt. % to 10 wt. %, or from about 1 wt. % to about 10 wt. %, or from 1 wt. % to less than 5 wt. %. For example, the polymeric chain extender may be present in an amount of about 1, 2, 3, 4, 5, 6, 7, 8, 9, or about 10 wt. %. In one aspect, the epoxy-containing polymeric chain extender may be present in an amount of 2.5 wt. % or about 2.5 wt. %.

### Catalysts

Certain catalysts may be used to catalyze the reactions described herein. One or more may be used herein to facilitate the formation of a network throughout the compositions disclosed. In one aspect, a catalyst may be used to facilitate the ring opening reaction of epoxy groups of the epoxy chain extender with the carboxylic acid end-group of the ester oligomer component. This reaction effectively results in chain extension and growth of the ester oligomer component via condensation, as well as to the in-situ formation of additional alcohol groups along the oligomeric backbone of the ester oligomer component. Furthermore, such a catalyst may subsequently facilitate the reaction of the generated alcohol groups with the ester groups of the ester oligomer component (a process called transesterification), leading to network formation. When such a catalyst remains active, and when free alcohol groups are available in the resulting network, the continuous process of transesterification reactions leads to a dynamic polymer network.

In some aspects, one or both of a first or second catalyst facilitates polycondensation. For example, the one or both of a first or second catalyst may facilitate polymerization of the alkylene terephthalate oligomer component. In some aspects, one or both of a first or second catalyst facilitates esterification. As an example, one or both of a first or second catalyst may facilitate esterification between the chain extender or cross-linking agent and the carboxylic acid and alcohol groups of the oligomer component. The one or both of a first or second catalyst may comprise an esterification (or transesterification catalyst) or a polycondensation catalyst. Thus, in some aspects, a catalyst catalyzes polycondensation by esterification of the alcohol and acid, and also the reaction between end-groups and chain-extender. A second catalyst may then catalyze transesterification to form cross-links. In some aspects, a single catalyst may catalyze all of the foregoing.

In various aspects of the present disclosure, one or more of a first catalyst or a second catalyst may be used in the preparation of the dynamically cross-linked compositions herein. As described herein, certain catalysts, such as the first or second catalyst, may be referenced as being a transesterification catalyst or a polycondensation catalyst. Although certain catalysts may be sufficient for use as both a transesterification and a polycondensation catalyst, for simplification, the following description details certain aspects of the transesterification catalyst and the polycondensation catalyst separately. It is understood that this separation and description is intended for example only and is not intended to be limiting regarding the use of various catalysts in various aspects of the processes described herein.

The desired one or more of a first or second catalyst or both may be combined with the ester oligomer and chain extender/cross-linking agent by a number of means. In one example, the one or more of a first or second catalyst or both may be compounded with the foregoing components. The catalyst may be compounded separately in a polymer matrix before adding to the ester oligomer and chain extender or cross-linking agent. As an example, a catalyst (e.g., a titanium (Ti) catalyst) may be present in the commercially available PBT resin. In some aspects, the catalyst may be added separately to one or more of the other components of the composition.

### Transesterification Catalyst

An example catalyst, as described herein, may be referred to as a transesterification catalyst. Generally, a transesterification catalyst facilitates the exchange of an alkoxy group of an ester by another alcohol. The transesterification catalyst as used herein facilitates reaction of free alcohol groups with ester groups in the backbone of the ester oligomer or its final dynamic polymer network. As mentioned before, these free alcohol groups are generated in-situ in a previous step by the ring-opening reaction of the epoxy chain extender with the carboxylic acid end-groups of the ester oligomer component. Certain transesterification catalysts are known in the art and are usually chosen from metal salts, for example, acetylacetonates, of zinc, tin, magnesium, cobalt, calcium, titanium, and zirconium. In certain aspects, the transesterification catalyst(s) is used in an amount up to about 25 wt. %, for example, about 0.001 wt. % to about 25 wt. %, of the total molar amount of ester groups in the ester oligomer component. In some aspects, the transesterification catalyst is used in an amount of from about 0.001 wt. % to about 10 wt. % or from about 0.001 wt. % to less than about 5 wt. %. Preferred aspects include about 0.001, about 0.05, about 0.1, and about 0.2 wt. % of catalyst, based on the number of ester groups in the ester oligomer component.

Suitable transesterification catalysts are also described in Otera, J. Chem. Rev. 1993, 93, 1449-1470. Tests for determining whether a catalyst will be appropriate for a given polymer system within the scope of the disclosure are described in, for example, U.S. Published Application No. 2011/0319524 and WO 2014/086974.

Tin compounds such as dibutyltinlaurate, tin octanote, dibutyltin oxide, dioxtyltin, dibutyldimethoxytin, tetraphenyltin, tetrabutyl-2,3-dichlorodistannoxane, and all other stannoxanes are envisioned as suitable catalysts. Rare earth salts of alkali metals and alkaline earth metals, particularly rare earth acetates, alkali metal and alkaline earth metals such as calcium acetate, zinc acetate, tin acetate, cobalt acetate, nickel acetate, lead acetate, lithium acetate, manganese acetate, sodium acetate, and cerium acetate are other catalysts that can be used. Salts of saturated or unsaturated fatty acids and metals, alkali metals, alkaline earth and rare earth metals, for example zinc stearate, are also envisioned as suitable catalysts. The catalyst may also be an organic compound, such as benzyldimethylamide or benzyltrimethylammonium chloride. These catalysts are generally in solid form, and advantageously in the form of a finely divided powder. In some aspects, a preferred catalyst is zinc(II)acetylacetonate. In further aspects, zinc(II)acetate is a preferred catalyst.

### Polycondensation Catalyst

In some aspects, the compositions of the present disclosure are prepared using a polycondensation catalyst. The polycondensation catalyst may increase the polymer chain length (and molecular weight) by facilitating the condensation reaction between alcohol and carboxylic acid end-groups of the ester oligomer component in an esterification reaction. Alternatively, this catalyst may facilitate the ring opening reaction of the epoxy groups in the epoxy chain extender with the carboxylic acid end-groups of the ester oligomer component. The polycondensation catalyst is used in an amount of between 10 parts per million (ppm) and 100 ppm with respect to the ester groups in the ester oligomer component. In some aspects, the polycondensation catalyst is used in an amount of from 10 ppm to 100 ppm or from 10 ppm to less than 75 ppm. Preferred aspects include 20 ppm, 30 ppm, 50 ppm of catalyst, based on the oligomer component of the present disclosure. In a preferred aspect, the polycondensation catalyst is used in an amount of 50 ppm or about 0.005 wt. %.

Various titanium (Ti) based compounds have been proposed as polycondensation catalysts. Described titanium-based catalysts include tetra-n-propyl titanate, tetraisopropyl titanate, tetra-n-butyl titanate, tetraphenyl titanate, tetracyclohexyl titanate, tetrabenzyl titanate, tetra-n-butyl titanate tetramer, titanium acetate, titanium glycolates, titanium oxalates, sodium or potassium titanates, titanium halides, titanate hexafluorides of potassium, manganese and ammonium, titanium acetylacetate, titanium alkoxides, titanate phosphites etc. The use of titanium based polycondensation catalysts in the production of polyesters has been described in EP0699700, U.S. Pat. No. 3,962,189, JP52062398, U.S. Pat. Nos. 6,372,879, and 6,143,837, for example. An exemplary titanium based polycondensation catalyst of the present disclosure is titanium(IV) isopropoxide, also known as tetraisopropyl titanate.

Other transesterification or polycondensation catalysts that can be used include metal oxides such as zinc oxide, antimony oxide, and indium oxide; metal alkoxides such as titanium tetrabutoxide, titanium propoxide, titanium isopropoxide, titanium ethoxide, zirconium alkoxides, niobium alkoxides, tantalum alkoxides; alkali metals; alkaline earth metals, rare earth alcoholates and metal hydroxides, for example sodium alcoholate, sodium methoxide, potassium alkoxide, and lithium alkoxide; sulfonic acids such as sulfuric acid, methane sulfonic acid, paratoluene sulfonic acid; phosphines such as triphenylphosphine, dimethylphenylphosphine, methyldiphenylphosphine, triterbutylphosphine; and phosphazenes.

### Additives

One or more additives may be combined with the components of the dynamic or pre-dynamic cross-linked polymer to impart certain properties to the polymer composition. Exemplary additives include: one or more polymers, ultraviolet agents, ultraviolet stabilizers, heat stabilizers, antistatic agents, anti-microbial agents, anti-drip agents, radiation stabilizers, pigments, dyes, fibers, fillers, plasticizers, fibers, flame retardants, antioxidants, lubricants, impact modifiers, wood, glass, and metals, and combinations thereof.

The compositions described herein may comprise a UV stabilizer for dispersing UV radiation energy. The UV stabilizer does not substantially hinder or prevent cross-linking of the various components of the compositions described herein. UV stabilizers may be hydroxybenzophenones; hydroxyphenyl benzotriazoles; cyanoacrylates; oxanilides; or hydroxyphenyl triazines. The compositions described herein may comprise heat stabilizers. Exemplary heat stabilizer additives include, for example, organophosphites such as triphenyl phosphite, tris-(2,6-dimethylphenyl)phosphite, tris-(mixed mono- and di-nonylphenyl)phosphite or the like; phosphonates such as dimethylbenzene phosphonate or the like; phosphates such as trimethyl phosphate, or the like; or combinations thereof.

The compositions described herein may comprise an antistatic agent. Examples of monomeric antistatic agents may include glycerol monostearate, glycerol distearate, glycerol tristearate, ethoxylated amines, primary, secondary and tertiary amines, ethoxylated alcohols, alkyl sulfates, alkylarylsulfates, alkylphosphates, alkylaminesulfates, alkyl sulfonate salts such as sodium stearyl sulfonate, sodium dodecylbenzenesulfonate or the like, quaternary ammonium salts, quaternary ammonium resins, imidazoline derivatives, sorbitan esters, ethanolamides, betaines, or the like, or combinations comprising at least one of the foregoing monomeric antistatic agents.

Exemplary polymeric antistatic agents may include certain polyesteramides polyether-polyamide (polyetheramide) block copolymers, polyetheresteramide block copolymers, polyetheresters, or polyurethanes, each containing polyalkylene glycol moieties polyalkylene oxide units such as polyethylene glycol, polypropylene glycol, polytetramethylene glycol, and the like. Such polymeric antistatic agents are commercially available, for example Pelestat™ 6321 (Sanyo) or Pebax™ MH1657 (Atofina), Irgastat™ P18 and P22 (Ciba-Geigy). Other polymeric materials may be used as antistatic agents are inherently conducting polymers such as polyaniline (commercially available as Panipol™ EB from Panipol), polypyrrole and polythiophene (commercially available from Bayer), which retain some of their intrinsic conductivity after melt processing at elevated temperatures. Carbon fibers, carbon nanofibers, carbon nanotubes, carbon black, or a combination comprising at least one of the foregoing may be included to render the compositions described herein electrostatically dissipative.

The compositions described herein may comprise anti-drip agents. The anti-drip agent may be a fibril forming or non-fibril forming fluoropolymer such as polytetrafluoroethylene (PTFE). The anti-drip agent can be encapsulated by a rigid copolymer as described above, for example styrene-acrylonitrile copolymer (SAN). PTFE encapsulated in SAN is known as TSAN. Encapsulated fluoropolymers can be made by polymerizing the encapsulating polymer in the presence of the fluoropolymer, for example an aqueous dispersion. TSAN can provide significant advantages over PTFE, in that TSAN can be more readily dispersed in the composition. An exemplary TSAN can comprise 50 wt % PTFE and 50 wt % SAN, based on the total weight of the encapsulated fluoropolymer. The SAN can comprise, for example, 75 wt % styrene and 25 wt % acrylonitrile based on the total weight of the copolymer. Alternatively, the fluoropolymer can be pre-blended in some manner with a second polymer, such as for, example, an aromatic polycarbonate or SAN to form an agglomerated material for use as an anti-drip agent. Either method can be used to produce an encapsulated fluoropolymer.

The compositions described herein may comprise a radiation stabilizer, such as a gamma-radiation stabilizer. Exemplary gamma-radiation stabilizers include alkylene polyols such as ethylene glycol, propylene glycol, 1,3-propanediol, 1,2-butanediol, 1,4-butanediol, meso-2,3-butanediol, 1,2-pentanediol, 2,3-pentanediol, 1,4-pentanediol, 1,4-hexandiol, and the like; cycloalkylene polyols such as 1,2-cyclopentanediol, 1,2-cyclohexanediol, and the like; branched alkylenepolyols such as 2,3-dimethyl-2,3-butanediol (pinacol), and the like, as well as alkoxy-substituted cyclic or acyclic alkanes. Unsaturated alkenols are also useful, examples of which include 4-methyl-4-penten-2-ol, 3-methyl-pentene-3-ol, 2-methyl-4-penten-2-ol, 2,4-dimethyl-4-penten-2-ol, and 9 to decen-1-ol, as well as tertiary alcohols that have at least one hydroxy substituted tertiary carbon, for example 2-methyl-2,4-pentanediol (hexylene glycol), 2-phenyl-2-butanol, 3-hydroxy-3-methyl-2-butanone, 2-phenyl-2-butanol, and the like, and cyclic tertiary alcohols such as 1-hydroxy-1-methyl-cyclohexane. Certain hydroxymethyl aromatic compounds that have hydroxy substitution on a saturated carbon attached to an unsaturated carbon in an aromatic ring can also be used. The hydroxy-substituted saturated carbon can be a methylol group (—CH₂OH) or it can be a member of a more complex hydrocarbon group such as —CR²⁴HOH or —CR²⁴₂OH wherein R²⁴ is a complex or a simple hydrocarbon. Specific hydroxy methyl aromatic compounds include benzhydrol, 1,3-benzenedimethanol, benzyl alcohol, 4-benzyloxy benzyl alcohol and benzyl alcohol. 2-Methyl-2,4-pentanediol, polyethylene glycol, and polypropylene glycol are often used for gamma-radiation stabilization.

The term “pigments” means colored particles that are insoluble in the resulting compositions described herein. Exemplary pigments include titanium oxide, carbon black, carbon nanotubes, metal particles, silica, metal oxides, metal sulfides or any other mineral pigment; phthalocyanines, anthraquinones, quinacridones, dioxazines, azo pigments or any other organic pigment, natural pigments (madder, indigo, crimson, cochineal, etc.) and mixtures of pigments. The pigments may represent from 0.05% to 15% by weight relative to the weight of the overall composition. Pigments, dyes or fibers capable of absorbing radiation may be used to ensure the heating of an article based on the compositions described herein when heated using a radiation source such as a laser, or by the Joule effect, by induction or by microwaves. Such heating may allow the use of a process for manufacturing, transforming or recycling an article made of the compositions described herein. The term “dye” refers to molecules that are soluble in the compositions described herein and that have the capacity of absorbing part of the visible radiation.

Exemplary fibers include glass fibers, carbon fibers, polyester fibers, polyamide fibers, aramid fibers, cellulose and nanocellulose fibers or plant fibers (linseed, hemp, sisal, bamboo, etc.) may also be envisaged.

Suitable fillers for the compositions described herein include: silica, clays, calcium carbonate, carbon black, kaolin, and whiskers. Other possible fillers include, for example, silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO2, aluminum oxide, magnesium oxide, or the like; calcium sulfate (as its anhydride, dihydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin comprising various coatings known in the art to facilitate compatibility with the polymeric matrix, or the like; single crystal fibers or “whiskers” such as silicon carbide, alumina, boron carbide, iron, nickel, copper, or the like; fibers (including continuous and chopped fibers) such as asbestos, carbon fibers, glass fibers, such as E, A, C, ECR, R, S, D, or NE glasses, or the like; sulfides such as molybdenum sulfide, zinc sulfide or the like; barium compounds such as barium titanate, barium ferrite, barium sulfate, heavy spar, or the like; metals and metal oxides such as particulate or fibrous aluminum, bronze, zinc, copper and nickel or the like; flaked fillers such as glass flakes, flaked silicon carbide, aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as cellulose, cotton, sisal, jute, starch, cork flour, lignin, ground nut shells, corn, rice grain husks or the like; organic fillers such as polytetrafluoroethylene; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as additional fillers and reinforcing agents such as mica, clay, feldspar, flue dust, fillite, quartz, quartzite, perlite, tripoli, diatomaceous earth, carbon black, or the like, or combinations comprising at least one of the foregoing fillers or reinforcing agents.

Plasticizers, lubricants, and mold release agents can be included. Mold release agent (MRA) will allow the material to be removed quickly and effectively. Mold releases can reduce cycle times, defects, and browning of finished product. There is considerable overlap among these types of materials, which may include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl) phosphate of hydroquinone and the bis(diphenyl) phosphate of bisphenol-A; poly-alpha-olefins; epoxidized soybean oil; silicones, including silicone oils; esters, for example, fatty acid esters such as alkyl stearyl esters, e.g., methyl stearate, stearyl stearate, pentaerythritol tetrastearate (PETS), and the like; combinations of methyl stearate and hydrophilic and hydrophobic nonionic surfactants comprising polyethylene glycol polymers, polypropylene glycol polymers, poly(ethylene glycol-co-propylene glycol) copolymers, or a combination comprising at least one of the foregoing glycol polymers, e.g., methyl stearate and polyethylene-polypropylene glycol copolymer in a suitable solvent; waxes such as beeswax, montan wax, paraffin wax, or the like.

Various types of flame retardants can be utilized as additives. In one aspect, the flame retardant additives include, for example, flame retardant salts such as alkali metal salts of perfluorinated C₁-C₁₆ alkyl sulfonates such as potassium perfluorobutane sulfonate (Rimar salt), potassium perfluoroctane sulfonate, tetraethylammonium perfluorohexane sulfonate, potassium diphenylsulfone sulfonate (KSS), and the like, sodium benzene sulfonate, sodium toluene sulfonate (NATS) and the like; and salts formed by reacting for example an alkali metal or alkaline earth metal (for example lithium, sodium, potassium, magnesium, calcium and barium salts) and an inorganic acid complex salt, for example, an oxo-anion, such as alkali metal and alkaline-earth metal salts of carbonic acid, such as sodium carbonate Na₂CO₃, potassium carbonate K₂CO₃, magnesium carbonate MgCO₃, calcium carbonate CaCO₃, and barium carbonate BaCO₃ or fluoro-anion complex such as lithium hexafluoroaluminate Li₃AlF₆, barium hexafluorosilicate BaSiF₆, potassium tetrafluoroborate KBF₄, potassium hexafluoraluminate K₃AlF₆, potassium aluminum fluoride KAlF₄, potassium hexafluorosilicate K₂SiF₆, and/or sodium hexafluoroaluminate Na₃AlF₆ or the like. Rimar salt and KSS and NATS, alone or in combination with other flame retardants, are particularly useful in the compositions disclosed herein. In certain aspects, the flame retardant does not contain bromine or chlorine.

The flame retardant additives may include organic compounds that include phosphorus, bromine, and/or chlorine. In certain aspects, the flame retardant is not a bromine or chlorine containing composition. Non-brominated and non-chlorinated phosphorus-containing flame retardants can include, for example, organic phosphates and organic compounds containing phosphorus-nitrogen bonds. Exemplary di- or polyfunctional aromatic phosphorus-containing compounds include resorcinol tetraphenyl diphosphate (RDP), the bis(diphenyl) phosphate of hydroquinone and the bis(diphenyl) phosphate of bisphenol-A, respectively, their oligomeric and polymeric counterparts, and the like. Other exemplary phosphorus-containing flame retardant additives include phosphonitrilic chloride, phosphorus ester amides, phosphoric acid amides, phosphonic acid amides, phosphinic acid amides, tris(aziridinyl) phosphine oxide, polyorganophosphazenes, and polyorganophosphonates.

The flame retardant optionally is a non-halogen based metal salt, e.g., of a monomeric or polymeric aromatic sulfonate or mixture thereof. The metal salt is, for example, an alkali metal or alkali earth metal salt or mixed metal salt. The metals of these groups include sodium, lithium, potassium, rubidium, cesium, beryllium, magnesium, calcium, strontium, francium and barium. Examples of flame retardants include cesium benzenesulfonate and cesium p-toluenesulfonate. See e.g., U.S. Pat. No. 3,933,734, EP 2103654, and US2010/0069543A1, the disclosures of which are incorporated herein by reference in their entirety.

Another useful class of flame retardant is the class of cyclic siloxanes having the general formula [(R)₂SiO]_{y} wherein R is a monovalent hydrocarbon or fluorinated hydrocarbon having from 1 to 18 carbon atoms and y is a number from 3 to 12. Examples of fluorinated hydrocarbon include, but are not limited to, 3-fluoropropyl, 3,3,3-trifluoropropyl, 5,5,5,4,4,3,3-heptafluoropentyl, fluorophenyl, difluorophenyl and trifluorotolyl. Examples of suitable cyclic siloxanes include, but are not limited to, octamethylcyclotetrasiloxane, 1,2,3,4-tetramethyl-1,2,3,4-tetravinylcyclotetrasiloxane, 1,2,3,4-tetramethyl-1,2,3,4-tetraphenylcyclotetrasiloxane, octaethylcyclotetrasiloxane, octapropylcyclotetrasiloxane, octabutylcyclotetrasiloxane, decamethylcyclopentasiloxane, dodecamethylcyclohexasiloxane, tetradecamethylcycloheptasiloxane, hexadecamethylcyclooctasiloxane, eicosamethylcyclodecasiloxane, octaphenylcyclotetrasiloxane, and the like. A particularly useful cyclic siloxane is octaphenylcyclotetrasiloxane.

Exemplary antioxidant additives include organophosphites such as tris(nonyl phenyl)phosphite, tris(2,4-di-t-butylphenyl)phosphite (“Irgafos™ 168” or “I-168”), bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)] methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants.

### Articles and Processes

Articles can be formed from the compositions described herein. Generally, the ester oligomer component, the monomeric chain extender, and the transesterification and polycondensation catalysts are combined and heated to provide a molten mixture which is reacted under decreased pressure to form the dynamic cross-linked compositions described herein. The compositions described herein can then form, shaped, molded, or extruded into a desired shape. The term “article” refers to the compositions described herein being formed into a particular shape. As an example, articles may be formed from the dynamic cross-linked polymer compositions of the present disclosure and may include composites, a thermoformed material, or a combination thereof. The articles may further comprise a solder bonded to the formed article. It is understood that such examples are not intended to be limiting, but are illustrative in nature. It is understood that the subject compositions may be used for various articles and end-use applications.

With thermosetting resins of the prior art, once the resin has hardened (i.e. reached or exceeded the gel point), the article can no longer be transformed or repaired or recycled. Applying a moderate temperature to such an article does not lead to any observable or measurable transformation, and the application of a very high temperature leads to degradation of this article. In contrast, articles formed from the dynamic cross-linked polymer compositions described herein, on account of their particular composition, can be transformed, repaired, or recycled by raising the temperature of the article.

From a practical point of view, this means that over a broad temperature range, the article can be deformed, with internal constraints being removed at higher temperatures. Without being bound by theory, it is believed that transesterification exchanges in the dynamic cross-linked polymer compositions are the cause of the relaxation of constraints and of the variation in viscosity at high temperatures. In terms of application, these materials can be treated at high temperatures, where a low viscosity allows injection or molding in a press. It should be noted that, contrary to Diels-Alder reactions, no depolymerization is observed at high temperatures and the material conserves its cross-linked structure. This property allows the repair of two parts of an article. No mold is necessary to maintain the shape of the components during the repair process at high temperatures. Similarly, components can be transformed by application of a mechanical force to only one part of an article without the need for a mold, since the material does not flow.

Raising the temperature of the article can be performed by any known means such as heating by conduction, convection, induction, spot heating, infrared, microwave or radiant heating. Devices for increasing the temperature of the article in order to perform the processes of described herein can include: an oven, a microwave oven, a heating resistance, a flame, an exothermic chemical reaction, a laser beam, a hot iron, a hot-air gun, an ultrasonication tank, a heating punch, etc. The temperature increase can be performed in discrete stages, with their duration adapted to the expected result.

Although the dynamic cross-linked polymer compositions do not flow during the transformation, by means of the transesterification reactions, by selecting an appropriate temperature, heating time and cooling conditions, the new shape may be free of any residual internal constraints. The newly shaped dynamic cross-linked polymer compositions are thus not embrittled or fractured by the application of the mechanical force. Furthermore, the article will not return to its original shape. Specifically, the transesterification reactions that take place at high temperature promote a reorganization of the crosslinking points of the polymer network so as to remove any stresses caused by application of the mechanical force. A sufficient heating time makes it possible to completely cancel these stresses internal to the material that have been caused by the application of the external mechanical force. This makes it possible to obtain stable complex shapes, which are difficult or even impossible to obtain by molding, by starting with simpler elemental shapes and applying mechanical force to obtain the desired more complex final shape. Notably, it is very difficult to obtain by molding shapes resulting from twisting. An article made from a dynamic cross-linked polymer composition can be heated and deformed, and upon returning to the original temperature, maintains the deformed shape. As such, articles in accordance with the present disclosure may comprises a shape generated by applying mechanical forces to a molded piece formed from the dynamic cross-linked polymer composition.

According to one variant, a process for obtaining and/or repairing an article based on a dynamic cross-linked polymer composition described herein comprises: placing in contact with each other two articles formed from a dynamic cross-linked polymer composition; and heating the two articles so as to obtain a single article. The heating temperature (T) is generally within the range from 50° C. to 250° C., including from 100° C. to 200° C.

An article made of dynamic cross-linked polymer compositions as described herein may also be recycled by direct treatment of the article, for example, the broken or damaged article is repaired by means of a transformation process as described above and may thus regain its prior working function or another function. Alternatively, the article is reduced to particles by application of mechanical grinding, and the particles thus obtained may then be used to manufacture a new article.

### ASPECTS OF THE DISCLOSURE

In various aspects, the present disclosure pertains to and includes at least the following aspects.

Aspect 1: A batch process of preparing a dynamic cross-linked polymer composition, the batch process comprising, consisting of, or consisting essentially of:

contacting an alkylene terephthalate oligomer component and one or more of a chain extender or cross-linking agent, the contacting being performed so as to form a first mixture;

heating the first mixture at a first temperature and a first pressure for a first residence time so as to form a molten mixture;

including one or more of a first and second catalyst in one or both of the first mixture or the molten mixture; and

heating the molten mixture at a second temperature and second pressure for a second residence time so as to give rise to a dynamically cross-linked composition having an intrinsic viscosity of between about 0.55 dl/g and about 1.35 dl/g and a carboxylic acid end group concentration of between about 0.1 mmol/kg and about 80 mmol/kg.

Aspect 2: The batch process of Aspect 1, wherein the first temperature is a temperature sufficient to melt the alkylene terephthalate oligomer component.

Aspect 3: The batch process of any of Aspects 1-2, wherein the alkylene terephthalate oligomer component is a butylene terephthalate oligomer.

Aspect 4: The batch process of any of Aspects 1-3, wherein the alkylene terephthalate oligomer component has an intrinsic viscosity of between about 0.13 dL/g and about 0.35 dL/g and a carboxylic acid end group concentration of between about 5 mmol/kg and about 180 mmol/kg.

Aspect 5: The batch process of any of Aspects 1-4, further comprising subjecting the dynamically cross-linked composition to a curing process.

Aspect 6: The batch process of any Aspects 1-5, wherein the second pressure is less than about 16 millibar.

Aspect 7: The batch process of any of Aspects 1-6, wherein the chain extender or cross-linking agent is present in an amount between about 0.1 wt. % and about 10 wt. % based on the total weight of the first mixture.

Aspect 8: The batch process of any of Aspects 1-7, wherein the one or more of the chain extender or cross-linking agent is reactive with carboxylic acid groups of the alkylene terephthalate oligomer component.

Aspect 9: The batch process of any of Aspects 1-8, wherein the one or more of the chain extender or cross-linking agent comprises a diepoxy, a diisocyanide, a dianhydride, a dioxazoline, a polyol, or a combination thereof.

Aspect 10: The batch process of any of Aspects 1-9, wherein the one or more of the first and second catalyst is present in an amount of between about 50 ppm and about 200 ppm based upon a total weight of the molten mixture.

Aspect 11: The batch process of any of Aspects 1-10, wherein the one or more of the first or second catalyst facilitates polymerization of the alkylene terephthalate oligomer component.

Aspect 12: The batch process of any of Aspects 1-11, wherein the one or more of the first or second catalyst facilitates esterification or polycondensation.

Aspect 13: The batch process of any of Aspects 1-12, wherein the one or more of the first or second catalyst facilitates esterification between carboxylic acid and alcohol of the alkylene terephthalate oligomer component and the chain extender or cross-linking agent.

Aspect 14: The batch process of any of Aspects 1-13, further comprising subjecting the dynamic cross-linked polymer composition to a polymer forming process so as to give rise to an article.

Aspect 15: A composition formed according to the batch process of any of Aspects 1-13, wherein the composition exhibits a capability of relaxing internal residual stresses at a characteristic timescale of between about 0.1 and about 100,000 seconds above a glass transition temperature of a product of the batch process of Aspect 1, as measured by stress relaxation rheology measurement.

Aspect 16: A process of forming a dynamically cross-linked composition, the process comprising, consisting of, or consisting essentially of:

effecting melt polycondensation of an ester oligomer component and one or more of a chain extender or cross-linking agent, in a reactor wherein pressure in the reactor is reduced to less than about 0.016 bar, so as to give rise to a dynamically cross-linked composition;

wherein the ester oligomer component has an intrinsic viscosity of between about 0.13 dl/g and about 0.35 dl/g and a carboxylic acid end group concentration of between about 5 mmol/kg and about 180 mmol/g; and

wherein the one or more chain extender or cross-linking agent or both is present in an amount between about 1 wt. % and about 5 wt. % of a total weight of the dynamically cross-linked composition, and

wherein the dynamically cross-linked composition exhibits a capability of relaxing internal residual stresses at a characteristic timescale of between about 0.1 seconds and about 100,000 seconds above a glass transition temperature of the ester oligomer component in a polymerized form, as measured by stress relaxation rheology measurement.

Aspect 17: A dynamically cross-linked composition formed according to Aspect 16.

Aspect 18: A dynamically cross-linked composition, the comprising, consisting of, or consisting essentially of:

a condensation product of an ester oligomer and one or more of a chain extender or cross-linking agent,

wherein the dynamically cross-linked composition exhibits a capability of relaxing internal residual stresses at a characteristic timescale of between about 0.1 and about 100,000 seconds above a glass transition temperature of the ester oligomer in a polymerized form, as measured by stress relaxation rheology measurement.

Aspect 19: The dynamically cross-linked composition of Aspect 18, further comprising one or more additives.

Aspect 20: The dynamically cross-linked composition of any of Aspects 18-19, wherein the one or more of the chain extender or cross-linking agent reacts with the ester oligomer in the presence of one or more catalysts to form the condensation product.

The following examples are provided to illustrate the compositions, processes, and properties of the present disclosure. The examples are merely illustrative and are not intended to limit the disclosure to the materials, conditions, or process parameters set forth therein.

### EXAMPLES

### Materials

BT-oligomer I obtained from Resin III plant (IV of 0.13 dL/g and CEG of 100 mmol/kg); BT-oligomer II obtained from Resin III plant (IV of 0.32 dL/g and CEG of 30 mmol/kg); Tetraisopropyl titanate (TPT) (Commercial Tyzor grade available from Dorse Ketal); BDO (available from BASF); Pyromellitic dianhydride (PMDA, available from Fisher); and Zinc (II) acetate (available from Fisher).

### General Testing Methods

Intrinsic viscosity (IV) of oligomers and poly(butylene terephthalates) was measured according to ASTM D2857-95 (2007) using an automatic Viscotek Microlab™ 500 series Relative Viscometer Y501. A 0.5 gram oligomer sample was fully dissolved in a 60:40 mixture (% volume) of phenol and 1,1,2,2-tetrachloroethane solution (available from Harrell Industries). Two measurements were taken for each sample, and the reported result was the average of the two measurements.

Carboxylic acid end group (CEG) concentration of oligomer and poly(butylene terephthalates) samples was measured in accordance with ASTM D7409-15 using a Metrohm-Autotitrator Titrando 907 with a 800 Dosino 2 milliliter (ml) dosing unit and a 814 USB sample processor. A Metrohm Solvotrode easyclean electrode was used. A 0.5 gram sample of oligomer was fully dissolved in 25 ml of O-cresol/dichloromethane solvent (3:1 volume ratio) at 80° C. After dissolving, the sample was cooled to room temperature and 50 ml of dichloromethane were added to the beaker. A sample blank was prepared in the similar way. The titrant used was a 0.01 mol/1 solution of potassium hydroxide (KOH) in isopropyl alcohol. The electrodes and titrant dosing were dipped into the sample solution and the titration was started. The titrant volume increment was 0.05 ml. The time between dosings was 15 seconds (s). The equivalence point was 28 mV. The quantity of KOH dosed in the titrated volume at the equivalence point was calculated and represents the CEG value in mmol/kg sample.

Oscillatory stress relaxation measurements were used to investigate the dynamic cross-linked network properties. Stress relaxation measurements were performed using an 8 mm parallel-plate geometry at a 3% strain with a fixed gap of 1 millimeter (mm). All the measurements were performed on samples after a post-curing step of a minimum of 30 minutes at 250 degree ° C.

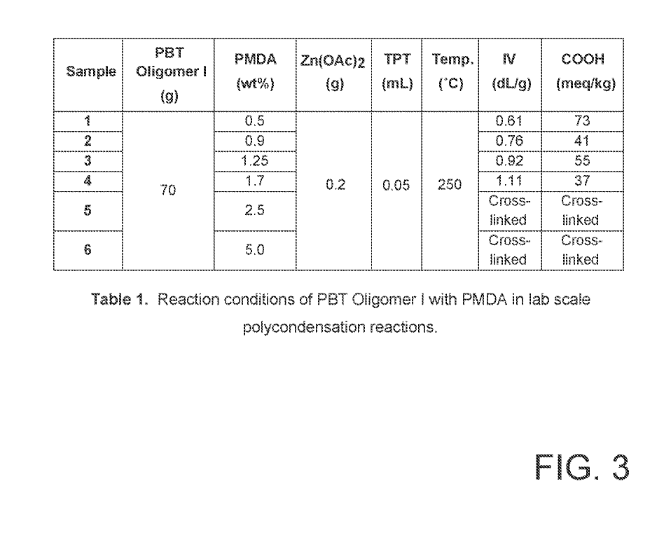

A small scale, lab batch process was performed. A dry 500 ml neck round bottom flask equipped with a mechanical stirrer and fitted with a reverse Dean-Stark trap having a condenser and nitrogen inlet, was charged with 70 g PBT-oligomer. The flask was placed in an oil bath of 250° C. After the oligomer was fully melted, the corresponding weight of chain extender, 0.2 g of zinc acetate and 0.05 mL of TPT were added in the flask under stirring. Once the mixture became homogenous, the agitator speed was set at 260 rpm and the vacuum was gradually applied and for about 5 minutes to reach −3 to −4 mbar. When torque of the stirring rod was 30 for 3 times, the stirring speed was set to 50% of the original speed. The afforded product was sampled at the end of the third torque built. Table 1 presented in FIG. 3 presents the reaction conditions, intrinsic viscosities, and carboxylic acid end group concentrations for the lab scale batch process.

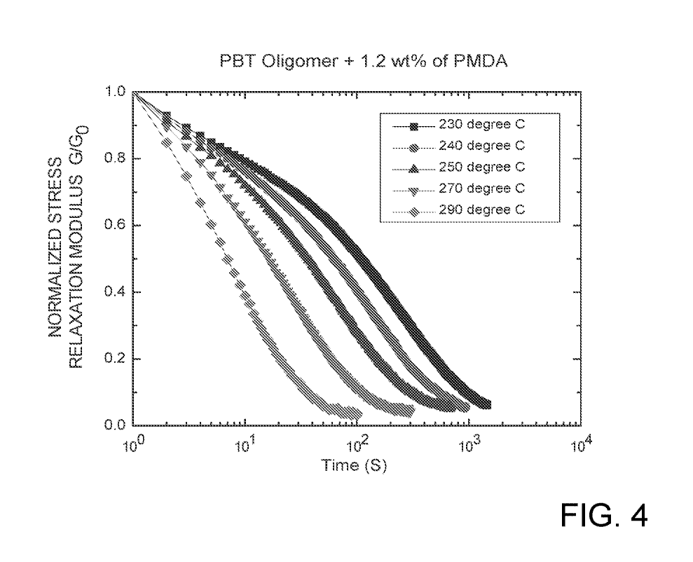

As shown in Table 1 of FIG. 3, and corresponding FIG. 4, the intrinsic viscosities increased substantially under vacuum and similarly increased with the loading of PMDA. At 1.7 wt. % PMDA loading, the intrinsic viscosity was 1.11 dl/g, while at higher loadings (2.5 and 5.0 wt. %) the products cross-linked hence IV and CEG could not be measured. Accordingly, it is believed that vacuum pressure condition is critical to the building of IV, which is closely correlated to molecular weight growth of polymers.

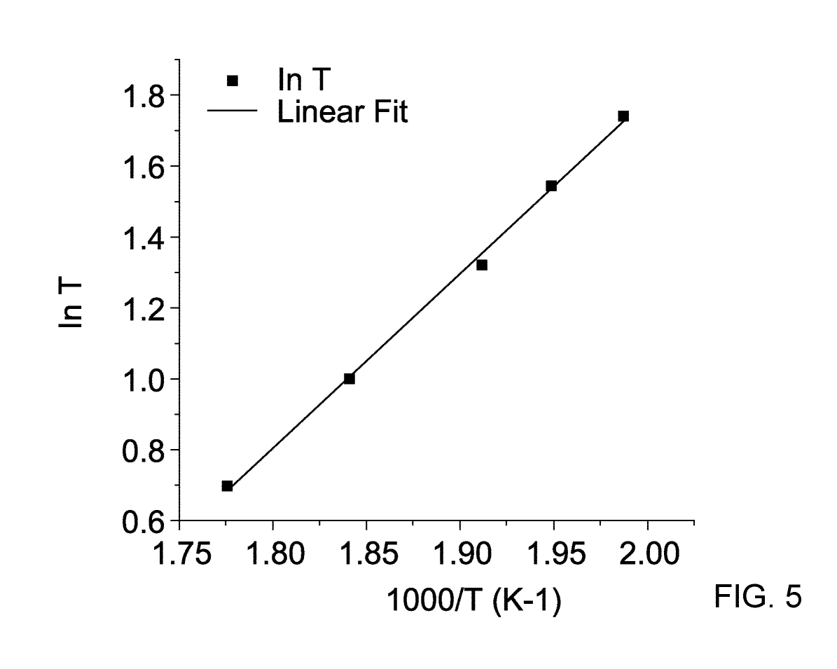

Stress relaxation analyses were performed on selected samples in the linear viscoelastic regime. Typically, a thermoplastic relaxes fast in a short period of time, while a classic thermoset does not show obvious relaxation below the degradation temperature of the composition. For a DCN, thermoset behavior is expected at lower temperatures, but at higher temperatures relaxation and the relaxation time may be dependent on temperature (i.e., the higher the temperature, the shorter time relaxation time). The samples prepared under vacuum, however, exhibited promising DCN behaviors. FIG. 4 presents the stress relaxation results for sample 3 with a PMDA loading of 1.25 wt. % and a Zn(OAc)₂ loading of 0.28 wt. % at various temperatures between 230 to 290° C. The stress relaxation analyses were performed after a post-curing step of a minimum 30 minutes at 250° C. As shown, at lower temperature, stress relaxes slower (gradual curve), while at elevated temperature network rearrangement becomes more active and so stress relaxes faster (steeper curve). The curves thus exhibit dynamic network behavior. Further, an Arrhenius plot of the log of the values of characteristic relaxation time (e) versus 1000/T shows linear relation (FIG. 5), also characteristic of the dynamically cross-linked network.

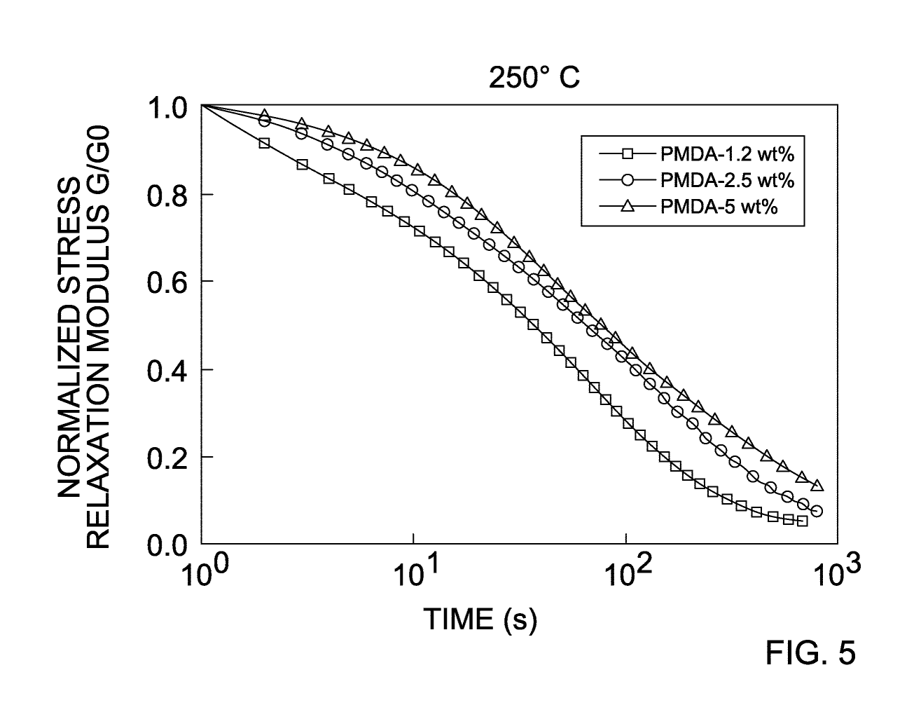

A comparison of the stress relaxation curves of the networks for different PMDA loadings at 250° C. (FIG. 6) suggested a trend that the dynamically cross-linked networks having a higher PMDA loading relax more slowly.

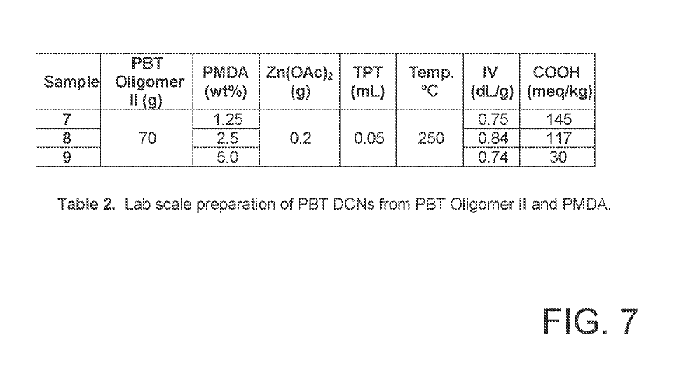

Table 2 presented in FIG. 7 similarly prepared dynamically cross-linked polymer compositions to those of Table 1, except that the oligomer comprises PBT-oligomer II, which has a greater intrinsic viscosity than PBT-oligomer I (compare IV of 0.32 dL/g and CEG of 30 mmol/kg to PBT-oligomer I at IV of 0.13 dL/g and CEG of 100 mmol/kg).

Three different loadings, i.e. 1.25, 2.5 and 5.0 wt. % of PMDA were used to reaction with PBT-oligomer II under the same conditions as PBT-oligomer I (Table 1, FIG. 3). Comparing to PBT-oligomer I, the intrinsic viscosities of PBT-DCN prepared from PBT-oligomer II are lower (Table 2, FIG. 7). The lower intrinsic viscosities correspond to a lower molecular weight and can be attributed to: a) the hydroxide (OH) end group concentration of PBT-oligomer II is lower than the OH end group concentration of PBT-oligomer I resulting in a less robust cross-linking reaction; b) the molecular weight between crosslinks may be higher for PBT-oligomer II because it has longer chain length, thus causing the crosslink density of PBT DCNs prepared from PBT-oligomer II to be lower than that of PBT DCNs prepared from PBT-oligomer I.

A plant scale process was performed. A 10 CV (cone vertical) helicone reactor, having a capacity of 200 liters (L), was used for the preparation of PBT DCN. The reactor was equipped with a special design of twin opposing helical blades with 270 degree twist and constructed of 316 SS with a 16 g polish finish. The blade speed could be varied from 1 to 65 revolutions per minute (rpm). The agitators were connected to a Constant Torque Inverter Duty Motor, which operated at 230/460 VAC, and 60 hertz, Hz. These agitators provided excellent surface area for the polymer melt to build molecular weight. The helicone reactor was also designed with an overhead condenser to condense the vapors in the esterification, transesterification (if any) and polymerization stages.

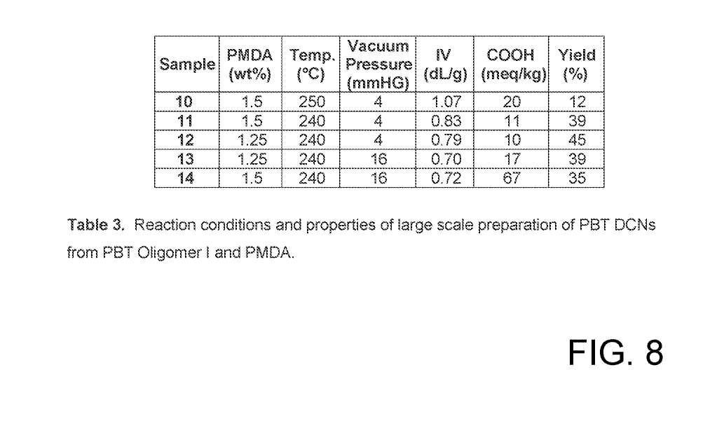

A quantity of 8.62 kg (19 lbs) of BT-oligomer was added into the reactor with 23 g of zinc acetate and indicated amount of chain extender (PMDA) at a reactor temperature of between 240° C. and 250° C. at 66.7% agitator speed. After the mixture formed a homogenous melt, 3 milliliters (ml) of TPT catalyst combined with 0.91 kg (2 lbs) of BDO was added. Refluxing at the condenser was allowed to slow, vacuum pressure was applied and increased to a rate of vacuum at 25 millimeters mercury per minute (mm Hg/min). At the second increase of vacuum pressure, the reaction was quenched. Table 3 presented in FIG. 8 the reaction conditions, intrinsic viscosities, carboxylic acid endgroup concentration, and yield of the large scale process.

Samples 10-14 exhibited DCN behavior as confirmed by stress relaxation analyses. However, in these large-scale reactions, the product was too viscous in the helicone reactor, particularly at the end of the drop. Low yields were attributed to the high viscosity. Factors including chain extender loading, temperature, and vacuum were investigated in order to improve the final yield of the reaction. A decrease in the chain extender loading, temperature, vacuum pressure appeared to improve the yield to greater than 40%.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While typical aspects have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. A batch process of preparing a dynamic cross-linked polymer composition, comprising:
contacting an alkylene terephthalate oligomer component and one or more of a chain extender or cross-linking agent, the contacting being performed so as to form a first mixture;
heating the first mixture at a first temperature and a first pressure for a first residence time so as to form a molten mixture;
including one or more of a first and second catalyst in one or both of the first mixture or the molten mixture; and
heating the molten mixture at a second temperature and second pressure for a second residence time so as to give rise to a dynamically cross-linked composition having an intrinsic viscosity of between about 0.55 dl/g and about 1.35 dl/g and a carboxylic acid end group concentration of between about 0.1 mmol/kg and about 80 mmol/kg.

2. The batch process of claim 1, wherein the first temperature is a temperature sufficient to melt the alkylene terephthalate oligomer component.

3. The batch process of claim 1, wherein the alkylene terephthalate oligomer component is a butylene terephthalate oligomer.

4. The batch process of claim 1, wherein the alkylene terephthalate oligomer component has an intrinsic viscosity of between about 0.13 dL/g and about 0.35 dL/g and a carboxylic acid end group concentration of between about 5 mmol/kg and about 180 mmol/kg.

5. The batch process of claim 1, further comprising subjecting the dynamically cross-linked composition to a curing process.

6. The batch process of claim 1, wherein the second pressure is less than about 16 millibar.

7. The batch process of claim 1, wherein the chain extender or cross-linking agent is present in an amount between about 0.1 wt. % and about 10 wt. % based on the total weight of the first mixture.

8. The batch process of claim 1, wherein the one or more of the chain extender or cross-linking agent is reactive with carboxylic acid groups of the alkylene terephthalate oligomer component.

9. The batch process of claim 1, wherein the one or more of the chain extender or cross-linking agent comprises a diepoxy, a diisocyanide, a dianhydride, a dioxazoline, a polyol, or a combination thereof.

10. The batch process of claim 1, wherein the one or more of the first and second catalyst is present in an amount of between about 50 ppm and about 200 ppm based upon a total weight of the molten mixture.

11. The batch process of claim 1, wherein the one or more of the first or second catalyst facilitates polymerization of the alkylene terephthalate oligomer component.

12. The batch process of claim 1, wherein the one or more of the first or second catalyst facilitates esterification or polycondensation.

13. The batch process of claim 1, wherein the one or more of the first or second catalyst facilitates esterification between carboxylic acid and alcohol of the alkylene terephthalate oligomer component and the chain extender or cross-linking agent.

14. The batch process of claim 1, further comprising subjecting the dynamic cross-linked polymer composition to a polymer forming process so as to give rise to an article.

15. A composition formed according to the batch process of claim 1, wherein the composition exhibits a capability of relaxing internal residual stresses at a characteristic timescale of between about 0.1 and about 100,000 seconds above a glass transition temperature of a product of the batch process of claim 1, as measured by stress relaxation rheology measurement.

16. A process of forming a dynamically cross-linked composition, comprising:
effecting melt polycondensation of an ester oligomer component and one or more of a chain extender or cross-linking agent, in a reactor wherein pressure in the reactor is reduced to less than about 0.016 bar, so as to give rise to a dynamically cross-linked composition;
wherein the ester oligomer component has an intrinsic viscosity of between about 0.13 dl/g and about 0.35 dl/g and a carboxylic acid end group concentration of between about 5 mmol/kg and about 180 mmol/g; and
wherein the one or more chain extender or cross-linking agent or both is present in an amount between about 1 wt. % and about 5 wt. % of a total weight of the dynamically cross-linked composition, and
wherein the dynamically cross-linked composition exhibits a capability of relaxing internal residual stresses at a characteristic timescale of between about 0.1 seconds and about 100,000 seconds above a glass transition temperature of the ester oligomer component in a polymerized form, as measured by stress relaxation rheology measurement.

17. A dynamically cross-linked composition formed according to claim 16.

18. A dynamically cross-linked composition, comprising:
a condensation product of an ester oligomer and one or more of a chain extender or cross-linking agent,
wherein the dynamically cross-linked composition exhibits a capability of relaxing internal residual stresses at a characteristic timescale of between about 0.1 and about 100,000 seconds above a glass transition temperature of the ester oligomer in a polymerized form, as measured by stress relaxation rheology measurement.

19. The dynamically cross-linked composition of claim 18, further comprising one or more additives.

20. The dynamically cross-linked composition of claim 18, wherein the one or more of the chain extender or cross-linking agent reacts with the ester oligomer in the presence of one or more catalysts to form the condensation product.
